(19) United States
(12) Patent Application Publication
(10) Pub. No.: US 2022/0147111 A1
(43) Pub. Date: May 12, 2022

(54) COMPUTING DEVICES WITH TRANSLATABLE KEYBOARD HOUSINGS

(71) Applicant: Hewlett-Packard Development Company, L.P., Spring, TX (US)

(72) Inventor: Jiaqi Zou, Houston, TX (US)

(73) Assignee: Hewlett-Packard Development Company, L.P., Spring, TX (US)

(21) Appl. No.: 17/296,754

(22) PCT Filed: Jul. 25, 2019
(86) PCT No.: PCT/US2019/043353

§ 371 Date: May 25, 2021

(51) Int. Cl. G06F 1/16

(52) U.S. Cl. CPC G06F 1/1669; G06F 1/1667; G06F 1/1647

(57) ABSTRACT

Example implementations relate to computing devices with translatable keyboard housings. In some examples, a computing device may include a first housing, a second housing, a first display included in the first housing, a second display included in the second housing, and a keyboard housing including a keyboard, where the keyboard housing is linearly translatable relative to the second housing to change an amount of alignment with the second housing.

### BACKGROUND

Computing devices can be portable to allow a user to carry or otherwise bring with the computing device while in a mobile setting. A computing device can allow a user to utilize computing device operations for work, education, gaming, multimedia, and/or other general use in a mobile setting.

### BRIEF DESCRIPTION OF THE DRAWINGS

FIG. 1 illustrates a perspective view of an example of a computing device with translatable keyboard housings having a keyboard housing in a first position consistent with the disclosure.

FIG. 2 illustrates a perspective view of an example of a computing device with translatable keyboard housings having a keyboard housing in a second position consistent with the disclosure.

FIG. 3 illustrates a perspective view of an example of a computing device with translatable keyboard housings having a keyboard housing in a third position consistent with the disclosure.

FIG. 4A illustrates a side view of an example of a computing device with translatable keyboard housings in a closed position consistent with the disclosure.

FIG. 4B illustrates a side view of an example of a computing device with translatable keyboard housings having a keyboard housing in a second position consistent with the disclosure.

FIG. 4C illustrates a side view of an example of a computing device with translatable keyboard housings having a keyboard housing in a third position consistent with the disclosure.

FIG. 5 illustrates a perspective view of an example of a computing device with translatable keyboard housings having a keyboard housing in a detached position consistent with the disclosure.

FIG. 6 illustrates a perspective view of an example of a computing device with translatable keyboard housings having a keyboard housing in a detached position consistent with the disclosure.

FIG. 7 illustrates a perspective view of an example of a computing device and a portion of a housing having a first portion of a slide rail consistent with the disclosure.

FIG. 8 illustrates a perspective view of an example of a back side of a keyboard housing having a second portion of a slide rail consistent with the disclosure.

FIG. 9A illustrates a perspective view of an example of a portion of the second portion of the slide rail having a disengaged positive locking pin consistent with the disclosure.

FIG. 9B illustrates a perspective view of an example of a portion of the second portion of the slide rail having an engaged positive locking pin consistent with the disclosure.

FIG. 10 illustrates an example flow chart for a computing device with translatable keyboard housings consistent with the disclosure.

### DETAILED DESCRIPTION

A user may utilize a computing device for various purposes while in a mobile setting. As used herein, a computing device can be, for example, a laptop computer and/or a notebook, among other types of computing devices.

Computing devices have been subject to hardware improvements, which can lead to increases in performance. For example, computing devices have had increased computing power in the central processing unit (CPU), random access memory (RAM), and/or graphics, among other computing device performance metrics.

Increases in computing device performance can allow a computing device to provide increased functionality. For example, computing devices can run more and/or increasingly complex programs, and/or allow for more multi-tasking functionality.

As a result of increased functionality, computing devices can provide more information to a user. However, display sizes of such computing devices may prevent this increase in information from being effectively displayed and/or communicated to a user. For instance, the amount of screen space available in a computing device may be too small to effectively display information to a user of the computing device.

Some computing devices may include larger displays in order to present more information to a user. As used herein, the term “display” refers to an output device that includes a display area that displays information provided by an electrical signal in a visual and/or tactile form. As used herein, the term “display area” refers to an area of a display that displays information. For example, a computing device can include a display area that can display information such as text, videos, and/or images, as a result of an electrical signal provided to the display from the computing device. However, the mobility of the computing device can be reduced as a result of a larger screen, as the computing device may be made larger as a consequence of the larger screen. Additionally, the larger size of the computing device may result in an increase in weight, which can discourage a user from carrying the computing device in a mobile setting.

In some examples, computing devices may include an additional external display. For example, an additional external display may be connected to the computing device in order to provide an additional display to present information to a user. However, an additional external display can reduce mobility of the computing device. Further, an additional external display can result in additional monetary cost and/or increased power consumption.

Computing devices with translatable keyboard housings according to the disclosure can utilize a computing device having a first display and a second display hidden by a keyboard housing of the computing device, where the keyboard housing may translate linearly relative to a second housing that includes the second display to expose and activate portions of a display area of the second display. By exposing and activating portions of the display area of the second display based on the location of the keyboard housing, the computing device can utilize an additional amount of display area to provide additional information to a user of the computing device while maintaining mobility of the computing device.

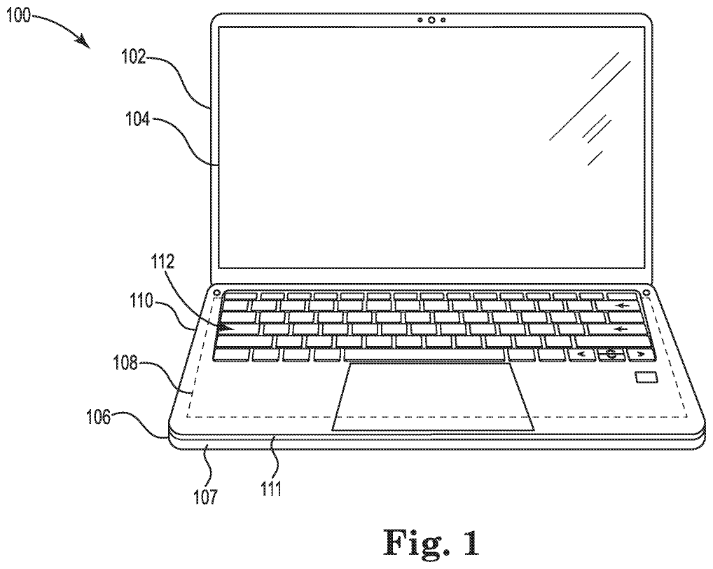

FIG. 1 illustrates a perspective view of an example of a computing device 100 with translatable keyboard housings having a keyboard housing 110 in a first position consistent with the disclosure. As illustrated in FIG. 1, the computing device 100 can include a first housing 102, second housing 106, and keyboard housing 110.

The computing device 100 can include a first housing 102. As used herein, the term “housing” refers to an outer shell of a device. For example, the first housing 102 can be an outer shell making up a portion of the computing device 100. The first housing 102 can include other components of the computing device 100, such as a display as is further described herein.

The first housing 102 can include a first display 104. As described above, the first display 104 can present information to a user, such as text, videos, and/or images, as a result of an electrical signal provided to the display from the computing device. For example, a user may utilize the computing device 100 to display a video via a display area of the first display 104.

The computing device 100 can include a second housing 106. The second housing 106 can be an outer shell making up a different portion of the computing device 100 than the first housing 102. The second housing 106 can include other components of the computing device 100, such as a display as is further described herein.

The second housing 106 can include a second display 108. As illustrated in FIG. 1, the second display 108 can be covered by a keyboard housing 110 when the keyboard housing 110 is in the first position, as illustrated in FIG. 1.

The computing device 100 can include a keyboard housing 110. The keyboard housing 110 can be an outer shell making up a further different portion of the computing device 100 than the first housing 102 and the second housing 106. The keyboard housing 110 can include other components of the computing device 100, such as a keyboard as is further described herein.

The keyboard housing 110 can include a keyboard 112. As used herein, the term “keyboard” refers to a device utilizing an arrangement of buttons (e.g., keys) to input information into a computing device. A user utilizing the computing device 100 can input information into the computing device via the keyboard 112. For example, a user may be working using the computing device 100 by inputting information into the computing device 100, among other examples.

The second housing 106 can be aligned with the keyboard housing 110 to define the first position of the keyboard housing 110. As illustrated in FIG. 1, the keyboard housing 110 can be adjacent to the second housing 106 (e.g., on top of the second housing 106, as oriented in FIG. 1) at the first position of the keyboard housing 110. An edge surface 111 of the keyboard housing 110 can be aligned with an edge surface 107 of the second housing 106 such that the edge surface 111 of the keyboard housing 110 and the edge surface 107 of the second housing 106 are parallel to each other. In other words, when the keyboard housing 110 is at the first position, the edge surface 111 and the edge surface 107 can be aligned.

At the first position of the keyboard housing 110, the keyboard housing 110 can cover the second display 108. As used herein, the term “cover” refers to a surface being shielded from view by an object. For example, the keyboard housing 110 can shield the second display 108 from view while the keyboard housing 110 is at the first position.

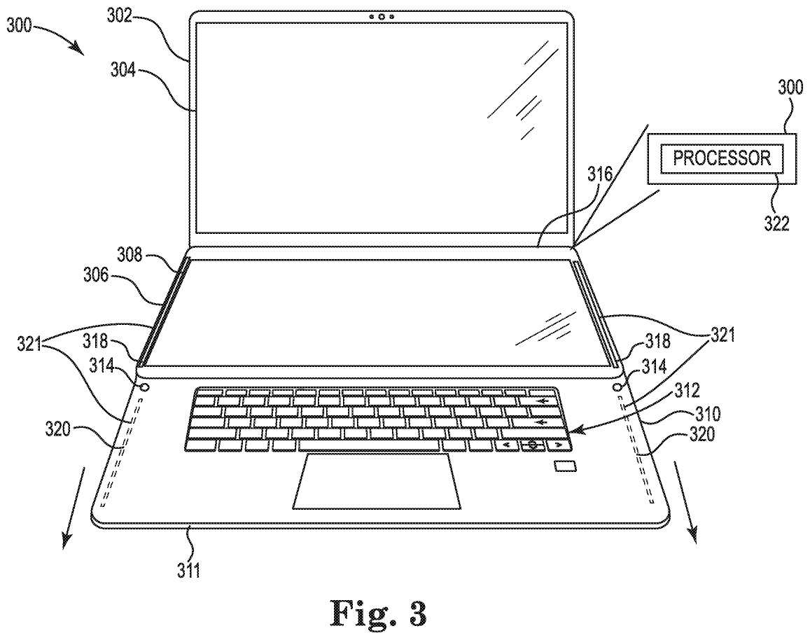

Although not illustrated in FIG. 1, the computing device 100 can include a processor (e.g., processor 322, as is further described in connection with FIG. 3). The processor can deactivate the entire display area of the second display 108 in response to determining the keyboard housing 110 is at the first position. For example, the display area of the second display 108 can be deactivated such that the display area does not display text, videos, and/or images. In other words, a user may utilize the computing device 100 while the keyboard housing 110 is in the first position by inputting information to the computing device via the keyboard 112 and/or viewing information displayed via the display area of the first display 104. However, no information may be presented to the user for viewing via the display area of the second display 108 as the second display 108 is entirely covered by the keyboard housing 110 and the second display area of the second display 108 is deactivated.

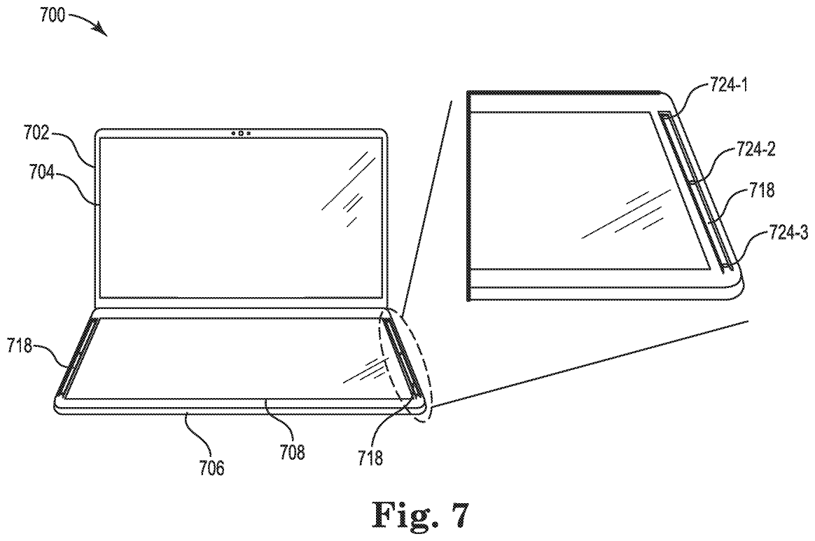

The processor can deactivate the entire display area of the second display 108 in response to determining the keyboard housing 110 is at the first position. Although not illustrated in FIG. 1, the computing device 100 can include sensors to determine the position of the keyboard housing 110. As used herein, the term “sensor” refers to a device which detects or measures events or changes in its environment. In some examples, a sensor can be an electrical connector. As used herein, the term “electrical connector” refers to an electromechanical device to create an electrical circuit. The electrical connector can transmit an electrical signal to the processor based on a position of the keyboard housing 110. For example, when the keyboard housing 110 is at the first position, an electrical circuit can be created to allow a particular electrical connector to transmit an electrical signal to the processor such that the processor can determine the position of the keyboard housing 110 based on the particular electrical connector. Different electrical connectors can correspond to different positions of the keyboard housing 110, allowing the processor to determine the position of the keyboard housing 110 based on the electrical connector transmitting the signal to the processor, as is further described in connection with FIGS. 7-9.

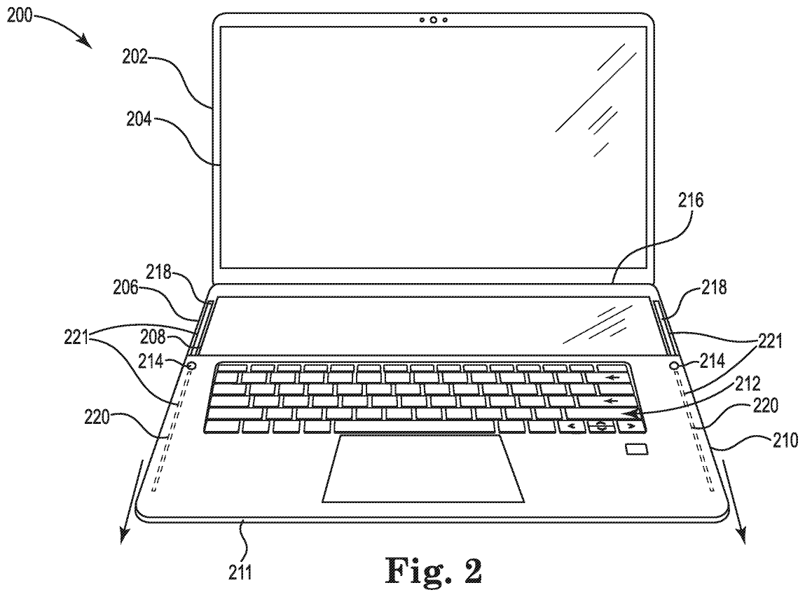

As illustrated in FIG. 1, the keyboard housing 110 is in the first position covering the second display 108. In an example in which a user may wish to utilize additional display area, the keyboard housing 110 can be linearly translatable relative to the second housing 106 to change an amount of alignment with the second housing 106. As used herein, the term “translate” refers to causing an object to move in a particular direction. For example, the keyboard housing 110 can be moved linearly (e.g., in a line) to change an amount of alignment with the second housing 106, which can expose a portion of the display area of the second display 108 (e.g., as is further described in connection with FIG. 2) or the entire display area of the second display 108 (e.g., as is further described in connection with FIG. 3).

FIG. 2 illustrates a perspective view of an example of a computing device 200 with translatable keyboard housings having a keyboard housing 210 in a second position consistent with the disclosure. As illustrated in FIG. 2, the computing device 200 can include a first housing 202, second housing 206, and keyboard housing 210.

As previously described in connection with FIG. 1, the computing device 200 can include a first housing 202 and a second housing 206. The first housing 202 can include the first display 204. The second housing 206 can include the second display 208.

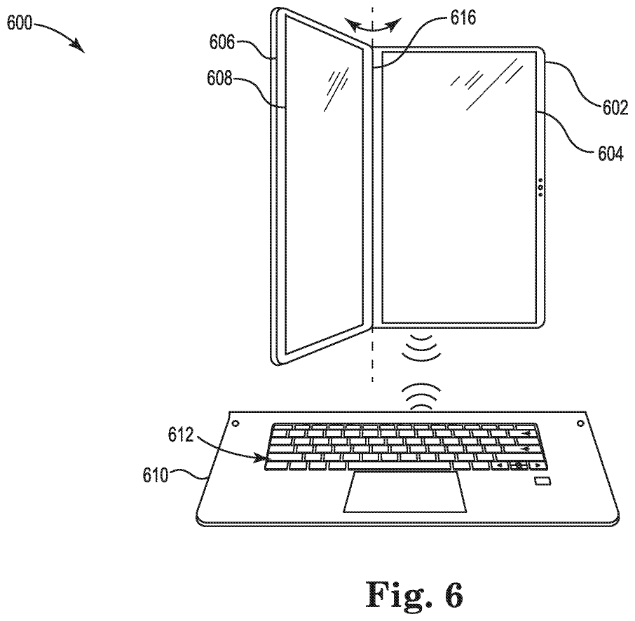

The computing device 200 can include a hinge 216. As used herein, the term “hinge” refers to a device that connects two objects to limit the two objects to a desired motion. For example, the hinge 216 can be attached to the first housing 202 and the second housing 206. The hinge 216 can limit the motion of the first housing 202 relative to the second housing 206 to a rotation. For example, the first housing 202 can be attached to the hinge 216 and the second housing 206 can be attached to the hinge 216 such that the first housing 202 and/or the second housing 206 can be rotated about a rotation axis relative to each other, where the rotation axis is defined by the hinge 216, as is further described in connection with FIG. 6.

The second housing 206 can include a first portion 218 of a slide rail 221. As used herein, the term “slide rail” refers to two complementary portions of a sliding track, where one portion of the track is located in and slides along the other portion of the track. For example, the first portion 218 of the slide rail 221 can be included in the second housing 206 and can mate with a second portion 220 of the slide rail 221, as is further described herein. The first portion 218 of the slide rail 221 can be located on the left side and the right side of the second housing 206 as oriented in FIG. 2. The slide rail 221 can assist with the linear translation of the keyboard housing 210, as is further described herein.

The computing device 200 can include a keyboard housing 210 having a keyboard 212. The keyboard housing 210 can include a second portion 220 of the slide rail 221. For example, the second portion 220 of the slide rail 221 can be included in the keyboard housing 210 and can mate with the first portion 218 of the slide rail 221. The second portion 220 of the slide rail 221 can be located in the first portion 218 of the slide rail 221 when mated and can slide in the first portion 218 of the slide rail 221 to assist with linear translation of the keyboard housing 210. The second portion 220 of the slide rail 221 can be located on the left side and the right side of the keyboard housing 210 as oriented in FIG. 2, and can be located on an opposite side of the keyboard housing 210 as the keyboard 212, as indicated in FIG. 2 by the dashed lines. Having the first portion 218 of the slide rail 221 on the left and right side of the second housing 206 and the complementary second portion 220 of the slide rail 221 on the corresponding left and right side of the keyboard housing 210 can assist translation of the keyboard housing 210 and ensure the left side and the right side of the keyboard housing are moved the same distances when translating the keyboard housing 210 to prevent the keyboard housing 210 from binding.

As previously described in connection with and illustrated in FIG. 1, the second housing 206 can be aligned with the keyboard housing 210 at a first position of the keyboard housing 210. However, a user of the computing device 200 may like to have additional display area. Accordingly, the keyboard housing 210 is linearly translatable to the second position of the keyboard housing 210, as is illustrated in FIG. 2 and further described herein.

The keyboard housing 210 is linearly translatable relative to the second housing 206 to the second position of the keyboard housing 210. Translating the keyboard housing 210 can change the amount of alignment with the second housing 206. For example, the edge surface 211 of the keyboard housing 210 is no longer aligned with an edge surface of the second housing 206 when the keyboard housing 210 is at the second position (e.g., as illustrated in FIG. 2) as a result of the edge surface 211 translating a distance away from the edge surface of the second housing 206.

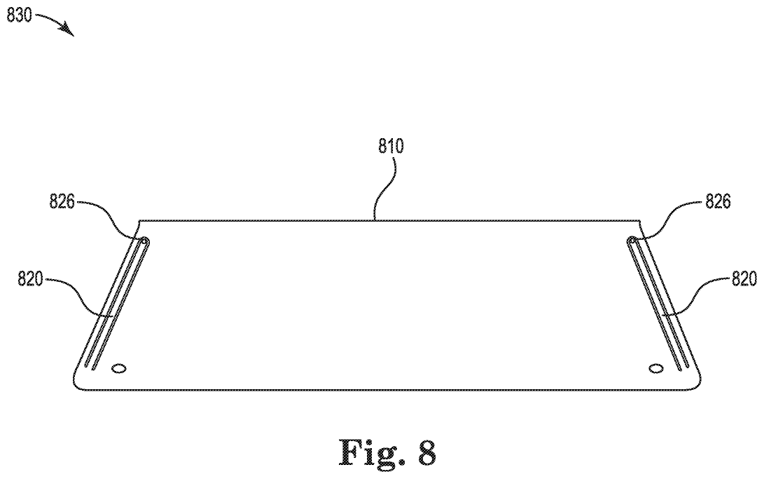

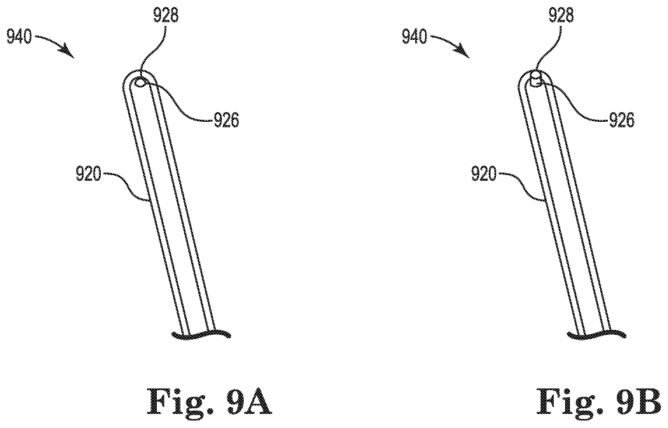

The keyboard housing 210 can include a release button 214. As used herein, the term “release button” refers to a device to cause another device to be freed from confinement. For example, the release button 214 can allow the keyboard housing 210 to be translatable in response to the release button 214 being depressed. Depressing the release button 214 can retract a positive locking pin from a locking pin socket, allowing translation of the keyboard housing 210, as is further described in connection with FIGS. 8, 9A, and 9B.

At the second position of the keyboard housing 210, the keyboard housing 210 can cover a different amount of the second display 208 than at the first position of the keyboard housing 210. For example, as illustrated in FIG. 2, a portion of the display area of the second display 208 can be exposed to the user and a portion of the display area of the second display 208 can be covered by the keyboard housing 210.

In some examples, the keyboard housing 210 can expose half of the display area of the second display 208 and cover half of the display area of the second display 208. However, examples of the disclosure are not so limited. For instance, the keyboard housing 210 can expose more than half of the display area of the second display 208 and cover less than half of the display area of the second display 208 at the second position, or as another example, the keyboard housing 210 can expose less than half of the display area of the second display 208 and cover more than half of the display area of the second display 208 at the second position.

Although not illustrated in FIG. 2, the computing device 200 can include a processor (e.g., processor 322, as is further described in connection with FIG. 3). The processor can activate a portion of the display area of the second display 208 in response to determining the keyboard housing 210 is at the second position. For example, the portion of the display area of the second display 208 that is exposed can be activated such that the exposed portion of the display area can display text, videos, and/or images. In other words, a user may utilize the computing device 200 while the keyboard housing 210 is in the second position by inputting information to the computing device via the keyboard 212, viewing information displayed via the display area of the first display 204, and/or viewing information displayed via the exposed display area of the second display 208. However, no information may be presented to the user for viewing via the covered display area of the second display 208 as the covered display area of the second display 208 is covered by the keyboard housing 210 and the covered display area of the second display 208 is deactivated.

The processor can activate the exposed display area of the second display 208 in response to determining the keyboard housing 210 is at the second position. Although not illustrated in FIG. 2, the computing device 200 can include sensors to determine the position of the keyboard housing 210. In some examples, the sensor can be an electrical connector. The electrical connector can transmit an electrical signal to the processor based on a position of the keyboard housing 210. For example, when the keyboard housing 210 is at the second position, an electrical circuit can be created to allow a particular electrical connector to transmit an electrical signal to the processor such that the processor can determine the position of the keyboard housing 210 to be the second position based on the particular electrical connector.

FIG. 3 illustrates a perspective view of an example of a computing device 300 with translatable keyboard housings having a keyboard housing 310 in a third position consistent with the disclosure. As illustrated in FIG. 3, the computing device 300 can include a first housing 302, second housing 306, and keyboard housing 310.

As previously described in connection with FIGS. 1 and 2, the computing device 300 can include a first housing 302, a second housing 306, a keyboard housing 310, and a hinge 316. The first housing 302 can include the first display 304. The second housing 306 can include the second display 308 and a first portion 318 of a slide rail 321. The keyboard housing 310 can include a keyboard 312 and a second portion 320 of the slide rail 321. The second housing 306 can be attached to the first housing 302 via the hinge 316 such that the first housing 302 and the second housing 306 are rotatable relative to each other about the hinge 316.

As previously described in connection with and illustrated in FIG. 1, the second housing 306 can be aligned with the keyboard housing 310 at a first position of the keyboard housing 310. However, a user of the computing device 300 may desire additional display area. Accordingly, the keyboard housing 310 is linearly translatable to the third position of the keyboard housing 310, as is illustrated in FIG. 3 and further described herein.

The keyboard housing 310 is linearly translatable relative to the second housing 306 to the third position of the keyboard housing 310. Translating the keyboard housing 310 can change the amount of alignment with the second housing 306. For example, the edge surface 311 of the keyboard housing 310 is no longer aligned with an edge surface of the second housing 306 when the keyboard housing 310 is at the third position (e.g., as illustrated in FIG. 3) as a result of the edge surface 311 translating a distance away from the edge surface of the second housing 306. The keyboard housing 310 is linearly translatable relative to the second housing 306 to the third position from the second position, the first position, or any other positions of the keyboard housing 310.

The keyboard housing 310 can include a release button 314. The release button 314 can allow the keyboard housing 310 to be translatable in response to the release button 314 being depressed. Depressing the release button 314 can retract a positive locking pin from a locking pin socket, allowing translation of the keyboard housing 310, as is further described in connection with FIGS. 8, 9A, and 9B.

At the third position of the keyboard housing 310, the keyboard housing 310 can cover a different amount of the second display 308 than at the first position or the second position of the keyboard housing 310. For example, as illustrated in FIG. 3, the entire display area of the second display 308 can be uncovered by the keyboard housing 310 at the third position of the keyboard housing 310 and exposed to the user.

The computing device 300 can include a processor 322. The processor 322 can activate the entire display area of the second display 308 in response to determining the keyboard housing 310 is at the third position. For example, the entire exposed display area of the second display 308 can be activated such that the entire display area can display text, videos, and/or images. In other words, a user may utilize the computing device 300 while the keyboard housing 310 is in the third position by inputting information to the computing device via the keyboard 312, viewing information displayed via the display area of the first display 304, and/or viewing information displayed via the entire display area of the second display 308.

The processor 322 can activate the entire display area of the second display 308 in response to determining the keyboard housing 310 is at the third position. Although not illustrated in FIG. 3, the computing device 300 can include sensors to determine the position of the keyboard housing 310. In some examples, the sensor can be an electrical connector. The electrical connector can transmit an electrical signal to the processor 322 based on a position of the keyboard housing 310. For example, when the keyboard housing 310 is at the third position, an electrical circuit can be created to allow a particular electrical connector to transmit an electrical signal to the processor 322 such that the processor 322 can determine the position of the keyboard housing 310 to be the third position based on the particular electrical connector.

The processor 322 may be a central processing unit (CPU), a semiconductor-based microprocessor, and/or other hardware devices suitable for retrieval and execution of non-transitory machine-readable instructions stored in a memory resource (not illustrated in FIG. 3). The processor 322 may fetch, decode, and execute the stored instructions to perform actions related to computing devices with translatable keyboard housings. As an alternative or in addition to retrieving and executing the stored instructions, the processor 322 may include a plurality of electronic circuits that include electronic components for performing the functionality of the stored instructions to perform actions related to computing devices with translatable keyboard housings.

The memory resource may be any electronic, magnetic, optical, or other physical storage device that stores the non-transitory machine-readable executable instructions and/or data. Thus, memory resource may be, for example, Random Access Memory (RAM), an Electrically-Erasable Programmable Read-Only Memory (EEPROM), a storage drive, an optical disc, and the like. The memory resource may be disposed within the computing device 300. Additionally, the memory resource may be a portable, external or remote storage medium, for example, that causes the computing device 300 to download the instructions from the portable/external/remote storage medium.

Although the keyboard housing 110, 210, 310 of the computing device 100, 200, and 300 is described in FIGS. 1-3 respectively as having three positions, examples of the disclosure are not so limited. For example, the keyboard housing 110, 210, 310 can include more than three positions or less than three positions, and a processor 322 can cause different exposed portions of the display area of the second display 108, 208, 308 to be activated accordingly.

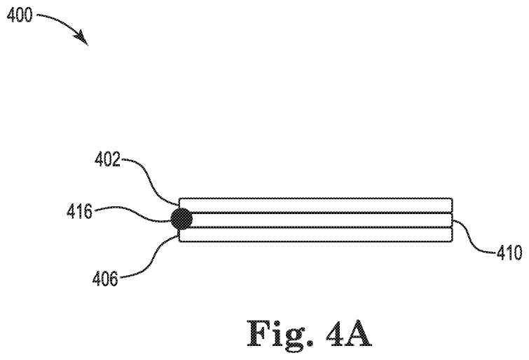

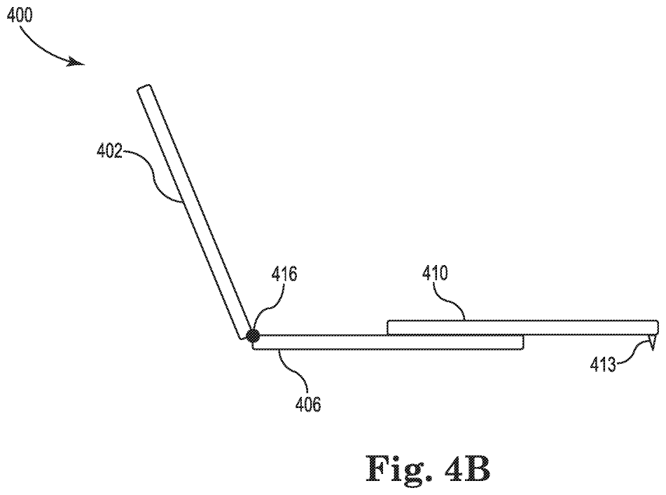

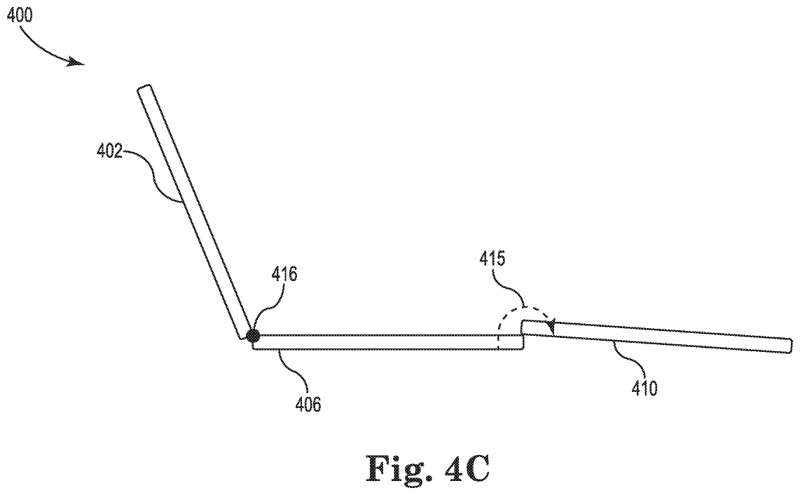

FIG. 4A illustrates a side view of an example of a computing device 400 with translatable keyboard housings in a closed position consistent with the disclosure. As illustrated in FIG. 4A, the computing device 400 can include a first housing 402, second housing 406, keyboard housing 410, and a hinge 416.

As illustrated in FIG. 4A, the computing device 400 can be in a closed position. In the closed position, the keyboard housing 410 can be at the first position such that the keyboard housing covers the entire display area of the second display included in the second housing 406. The keyboard housing 410 can be positioned between the first housing 402 and the second housing 406.

In the closed position of computing device 400, the display area of the first display included in the first housing 402, the display area of the second display included in the second housing 406, and the keyboard included in the keyboard housing can be protected by the respective housings 402, 406, and 410. Accordingly, the computing device 400 can be carried by a user in a mobile setting.

FIG. 4B illustrates a side view of an example of a computing device with translatable keyboard housings having a keyboard housing in a second position consistent with the disclosure. As illustrated in FIG. 4B, the computing device 400 can include a first housing 402, second housing 406, keyboard housing 410, and a hinge 416.

As illustrated in FIG. 4B, the keyboard housing 410 can be at the second position. When at the second position, a first amount of the keyboard housing 410 can cover the display area of the second display of the second housing 406 and a second amount of the housing can extend and hang beyond the second housing 406.

In some examples the keyboard housing 410 can include a stand 413. As used herein, the term “stand” refers to a piece of material attached to an object to prop up and support the object. For example, the stand 413 can be a piece of material to prop up and support the keyboard housing 410 when the keyboard housing 410 is at the second position. When a user is utilizing the keyboard of the keyboard housing 410, the user may be applying pressure on the keyboard housing 410 (e.g., as a result of their hands and/or fingers touching the keyboard and/or keyboard housing 410), and the stand 413 can support the keyboard housing 410 to avoid shear stresses to the keyboard housing 410.

In some examples, the stand 413 may be a positive locking pin. As used herein, the term “positive locking pin” refers to a piece of material used to fasten an object, where the piece of material is normally engaged and is disengaged in response to an action. For example, a positive locking pin may protrude from the keyboard housing 410 which can support the keyboard housing 410 to avoid shear stresses to the keyboard housing 410. The positive locking pin may be engaged and protruding a first distance from the keyboard housing 410 while the second portion of the slide rail of the keyboard housing is in the first portion of the slide rail of the second housing, and can fully extend (e.g., be fully engaged) and protrude a second distance from the keyboard housing 410 to a surface of a work area the computing device 400 is located on. For example, the positive locking pin may protrude the second distance when the portion of the second portion of the slide rail of the keyboard housing 410 is derailed from the first portion of the slide rail of the second housing. The positive locking pin to support the keyboard housing 410 may be a different positive locking pin than the positive locking pin described in connection with FIGS. 8, 9A, and 9B.

In some examples, the stand 413 may be a piece of material rotatably fixed to the keyboard housing 410. For example, the stand 413 may be rotate (e.g., pivot) from a rest position to a support position (e.g., as illustrated in FIG. 4B) to support the keyboard housing 410. The stand 413 may be rotated automatically (e.g., via a spring or other mechanism) when the keyboard housing 410 is moved to the second position, may be rotated manually (e.g., by a user), etc.

FIG. 4C illustrates a side view of an example of a computing device 400 with translatable keyboard housings having a keyboard housing 410 in a third position consistent with the disclosure. As illustrated in FIG. 4C, the computing device 400 can include a first housing 402, second housing 406, keyboard housing 410, and a hinge 416.

As illustrated in FIG. 4C, the keyboard housing 410 can be at the third position. When at the third position, the keyboard housing 410 can be oriented at an angle 415 relative to the second housing 406. The angle 415 can be such that the keyboard housing 410 can be ergonomically oriented for a user to allow the user to utilize the keyboard of the keyboard housing 410 without discomfort or pain.

The keyboard housing 410 can be oriented at a reflex angle 415 relative to the second housing 406 to achieve the ergonomic orientation. As used herein, the term “reflex angle” refers to an angle greater than 180° but less than 360°. For example, relative to a base of the second housing 406, the reflex angle 415 can be 200°, although examples of the disclosure are not so limited. For instance, the reflex angle 415 can be less than 200° (but not less than 180°) or greater than 200°.

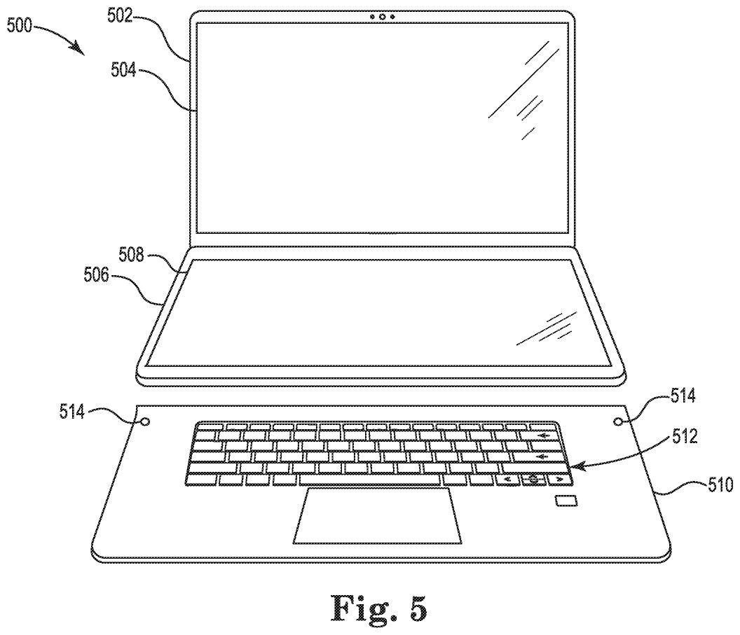

FIG. 5 illustrates a perspective view of an example of a computing device 500 with translatable keyboard housings having a keyboard housing 510 in a detached position consistent with the disclosure. As illustrated in FIG. 5, the computing device 500 can include a first housing 502, second housing 506, and keyboard housing 510.

As previously described in connection with FIGS. 1-3, the computing device 500 can include a first housing 502, a second housing 506, and a keyboard housing 510. The first housing 502 can include the first display 504. The second housing 506 can include the second display 508. The keyboard housing 510 can include a keyboard 512.

As previously described in connection with FIG. 3, the keyboard housing 510 is linearly translatable relative to the second housing 506 to the third position of the keyboard housing 510 to expose and activate the entire display area of the second display 508. In some examples, the keyboard housing 510 is detachable from the second housing 506, as is further described herein.

The keyboard housing 510 can be detached from the second housing 506. For example, while the keyboard housing 510 is at the third position, the release button 514 can be depressed to retract a positive locking pin from a locking pin socket to allow the keyboard housing 510 to detach from the second housing 506. Although not illustrated in FIG. 5, the computing device 500 can include a slide rail (e.g., slide rail 221, 321, previously described in connection with FIGS. 2 and 3, respectively). The keyboard housing 510 can be detached from the second housing 506 by sliding the keyboard housing 510 such that the second portion of the slide rail (e.g., second portion 220 of the slide rail, previously described in connection with FIG. 2) can slide out of the first portion of the slide rail (e.g., first portion 218 of the slide rail, previously described in connection with FIG. 2). The keyboard housing 510 can then be in a detached position. The keyboard 512 can be wirelessly connectable to a processor (e.g., processor 322, previously described in connection with FIG. 3) of the computing device 500, as is further described in connection with FIG. 6.

FIG. 6 illustrates a perspective view of an example of a computing device 600 with translatable keyboard housings having a keyboard housing 610 in a detached position consistent with the disclosure. As illustrated in FIG. 6, the computing device 600 can include a first housing 602, second housing 606, and keyboard housing 610.

The computing device 600 can include the first housing 602, the second housing 606, and the keyboard housing 610. The first housing 602 can include the first display 604. The second housing 606 can include the second display 608. The keyboard housing 610 can include a keyboard 612. The second housing 606 can be attached to the first housing 602 via the hinge 616 such that the first housing 602 and the second housing 606 are rotatable relative to each other about the rotation axis 617 defined by the hinge 616.

The keyboard 612 can be wirelessly connectable to a processor (e.g., processor 322, previously described in connection with FIG. 3) of the computing device 600. The keyboard 612 can be wirelessly connectable such that a user may utilize the computing device 600 while the keyboard housing 610 is in the detached position by inputting information to the keyboard 612, and having the information be wirelessly transmitted to the processor of the computing device 600. Information may be input via keystrokes of the keys, via a trackpad of the keyboard 612, by voice via a microphone of the keyboard 612 (e.g., not illustrated in FIG. 6), among other input mechanisms.

The keyboard 612 can be wirelessly connected the processor of the computing device 600 via a wireless network relationship. Examples of such a network relationship can include a wireless local area network (WLAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WMAX), infrared (IR) communication, Public Switched Telephone Network (PSTN), radio waves, and/or the Internet, among other types of network relationships.

The processor can determine the keyboard housing 610 is in the detached position. Although not illustrated in FIG. 6, the computing device 600 can include sensors to determine the position of the keyboard housing 610. In some examples, the sensor can be an electrical connector. The electrical connector can fail to transmit an electrical signal to the processor based on a position of the keyboard housing 610. For example, when the keyboard housing 610 is in the detached position, an electrical circuit may not be able to be created, resulting in a lack of transmission of an electrical signal to the processor. As a result of the lack of transmission of the electrical signal, the processor can determine the position of the keyboard housing 610 to be in the detached position.

The processor can determine the keyboard housing 610 is in the detached position after not receiving an electrical signal from an electrical connector for a predetermined period of time. The predetermined period of time may be, for instance, ten seconds. For example, after ten seconds the processor does not receive an electrical signal from an electrical connector, the processor may determine the keyboard housing 610 is in the detached position. The predetermined period of time is not limited to ten seconds. For example, the predetermined period of time may be more than ten seconds or less than ten seconds.

In some examples, in response to determining the keyboard housing 610 is at the detached position, the processor can cause the first display 604 and/or the second display 608 to operate in a tablet mode. As used herein, the term “tablet mode” refers to a mode of operation of a computing device in which a touchscreen display acts as a main input device. For example, the first display 604 and/or the second display 608 can be touch-screen displays that can receive inputs via the display areas of the first display 604 and/or the second display 608. The first display 604 and/or the second display 608 can receive inputs via a stylus, a human touch input (e.g., a user's finger or fingers), etc., and can allow for gesture input such as pinching/spreading of fingers to zoom, tapping to select, swiping to scroll, among other inputs and associated actions.

In some examples, in response to determining the keyboard housing 610 is at the detached position, the processor can cause the first display 604 and/or the second display 608 to operate in a dual-screen desktop mode. As used herein, the term “dual-screen desktop mode” refers to a mode of operation of a computing device in which information is presented on multiple display devices. For example, the first display 604 and the second display 608 can both display information such as text, videos, and/or images. The information may span both the first display 604 and the second display 608, may be dragged from the first display 604 to the second display 608 and/or vice versa, may have different information presented on the first display 604 than the second display 608, among other display functions.

The first housing 602 and the second housing 606 can be oriented in any orientation when the keyboard housing 610 is in the detached position. For example, the first housing 602 and the second housing 606 can be oriented at an angle (e.g., as illustrated in FIG. 6), can be positioned close to or far away from the keyboard housing 610, etc. Further, the angle between the first housing 602 and the second housing 606 may be modified by rotating the first housing 602 relative to the second housing 606 and/or vice versa about the rotation axis 617 defined by the hinge 616. This can allow the user of the computing device 600 to orient the first display 604 and/or the second display 608 to an orientation they are comfortable with for use in a tablet mode or a dual-screen desktop mode, allowing the user to view additional information while using the computing device 600. In some examples, the first housing 602 and the second housing 606 may be supported by an additional stand (e.g., not illustrated in FIG. 6).

FIG. 7 illustrates a perspective view of an example of a computing device 700 and a portion of a housing 706 having a first portion 718 of a slide rail consistent with the disclosure. As illustrated in FIG. 7, the computing device 700 can include a first housing 702 and second housing 706.

The computing device 700 can include a first housing 702 and a second housing 706. The first housing 702 can include the first display 704. The second housing 706 can include the second display 708. The computing device 700 can further include a keyboard housing having a keyboard (e.g., not illustrated in FIG. 7), where the keyboard housing can be in the detached position.

The second housing 706 can include a first portion 718 of a slide rail. As illustrated in the close-up view of the portion of the second housing 706 in FIG. 7, the first portion 718 of the slide rail can be included in the second housing 706. The first portion 718 can mate with a second portion of the slide rail, as is further described in connection with FIG. 8. The first portion 718 of the slide rail can be located on the left side and the right side of the second housing 706 as oriented in FIG. 7 and can assist with the linear translation of the keyboard housing having a second portion of the slide rail (e.g., to make up the slide rail 221, 321, previously described in connection with FIGS. 2 and 3), as previously described in connection with FIGS. 1-3.

As illustrated in the close-up view of the portion of the second housing 706 in FIG. 7, the first portion 718 of the slide rail can include locking pin sockets 724-1, 724-2, 724-3 (referred to collectively as locking pin sockets 724). As used herein, the term “locking pin socket” refers to a hollow part to receive another object. For example, the locking pin sockets 724 can receive a positive locking pin, as is further described in connection with FIG. 8.

As previously described in connection with FIGS. 1-3 and 6, the computing device 700 can include a processor to determine a position of the keyboard housing using signals transmitted from electrical connectors. The locking pin sockets 724 can include electrical connectors such that, when a positive locking pin is received by one of the locking pin sockets 724, an electrical circuit is completed and a signal can be sent to the processor such that the processor can determine the position of the keyboard housing. For instance, when a positive locking pin is received by locking pin socket 724-1, an electrical circuit can be completed and as a result, an electrical connector located in the locking pin socket 724-1 can send a signal to the processor to indicate the keyboard housing is at the first position and the processor can deactivate the entire display area of the second display 708. When a positive locking pin is received by locking pin socket 724-2, an electrical circuit can be completed and as a result, an electrical connector located in the locking pin socket 724-2 can send a signal to the processor to indicate the keyboard housing is at the second position and the processor can activate and/or deactivate corresponding portions of the visible and/or covered portions of the display area of the second display 708, respectively. Similarly, when a positive locking pin is received by locking pin socket 724-3, an electrical circuit can be completed and as a result, an electrical connector located in the locking pin socket 724-3 can send a signal to the processor to indicate the keyboard housing is at the third position and the processor can activate the entire display area of the second display 708.

Although the first portion 718 is illustrated in FIG. 7 as including three locking pin sockets 724, examples of the disclosure are not so limited. For example, the first portion 718 can include more than three locking pin sockets or less than three locking pin sockets.

In some examples, the electrical connectors included in the locking pin sockets 724 can be pogo pin connectors. As used herein, the term “pogo pin connector” refers to a device to connect to a pogo pin. For example, when a pogo pin located on a positive locking pin is received by one of the locking pin sockets 724 (e.g., locking pin socket 724-3), the pogo pin can connect to the pogo pin connector included in the locking pin socket 724-3 and complete an electrical circuit to cause a signal to be sent to the processor to indicate the keyboard housing is at the third position and the processor can activate the entire display area of the second display 708, as is further described in connection with FIG. 8.

FIG. 8 illustrates a perspective view of an example of a back side 830 of a keyboard housing 810 having a second portion 820 of a slide rail consistent with the disclosure. As illustrated in FIG. 8, the keyboard housing 810 can include the second portion 820 of the slide rail.

The keyboard housing 810 can include the second portion 820 of the slide rail. As illustrated in FIG. 8, the second portion 820 of the slide rail can be included in the keyboard housing 810. The second portion 820 can mate with the first portion of the slide rail included in the second housing, as previously described in connection with FIG. 7. The second portion 820 of the slide rail can be located on the left side and the right side of the keyboard housing 810 as oriented in FIG. 8 and can assist with the linear translation of the keyboard housing 810 in conjunction with a first portion of the slide rail (e.g., included on the second housing to make up the slide rail 221, 321, previously described in connection with FIGS. 2 and 3), as previously described in connection with FIGS. 1-3.

The keyboard housing 810 can include a positive locking pin 826. As previously described herein, the positive locking pin 826 can be normally engaged and can be disengaged in response to an action. For example, the positive locking pin 826 can normally protrude from the keyboard housing 810 (e.g., through an aperture in the second portion 820 of the slide rail), and can retract in response to a release button (e.g., release button 214, previously described in connection with FIG. 2) being pressed.

Due to the positive locking pin 826 normally protruding from the keyboard housing 810, the positive locking pin 826 can engage with a locking pin socket (e.g., locking pin sockets 724, previously described in connection with FIG. 7) to secure the keyboard housing 810 at a particular position relative to the second housing of the computing device. A user depressing the release button can cause the positive locking pin 826 to retract so the keyboard housing 810 can be linearly translatable along the slide rail to another position.

In some examples the positive locking pin 826 can include an electrical contact. As used herein, the term “electrical contact” refers to an electromechanical device to create an electrical circuit. In some examples, the electrical contact can be a pogo pin. As used herein, the term “pogo pin” refers to a spring-loaded electromechanical device having an integrated spring to prevent intermittent connections.

The positive locking pin 826 having the pogo pin can be received by a locking pin socket to engage the electrical contact (e.g., the pogo pin connector) located in the locking pin socket. As a result of the pogo pin engaging the pogo pin connector, an electrical circuit is completed and a signal can be sent to the processor such that the processor can determine a particular position of the keyboard housing 810.

As described above, the release button included on the keyboard housing 810 can be depressed to disengage the electrical contact (e.g., the pogo pin connector) located in the locking pin socket from the pogo pin. Depressing the release button can retract the positive locking pin and pogo pin and allow the keyboard housing 810 to linearly translate. The positive locking pin 826 can again protrude and the pogo pin can engage with another locking pin socket in response to the release button being released.

FIG. 9A illustrates a perspective view of an example of a portion 940 of the second portion 920 of the slide rail having a disengaged positive locking pin 926 consistent with the disclosure. The positive locking pin 926 can include an electrical contact 928.

As illustrated in FIG. 9A, the positive locking pin 926 can be retracted. The positive locking pin 926 can be retracted as a result of the release button (e.g., release button 214, previously described in connection with FIG. 2) being depressed. As a result of the positive locking pin 926 being depressed, the keyboard housing (e.g., not illustrated in FIG. 9A) can be linearly translatable, as previously described in connection with FIGS. 1-3.

The positive locking pin 926 can include an electrical contact 928. In some examples, the electrical contact 928 can be a pogo pin. As illustrated in FIG. 9A, the positive locking pin 926 is retracted and as a result, the pogo pin does not make contact with an electrical connector (e.g., a pogo pin connector) included in a locking pin socket, allowing the keyboard housing to be linearly translatable.

FIG. 9B illustrates a perspective view of an example of a portion 940 of the second portion 920 of the slide rail having an engaged positive locking pin 926 consistent with the disclosure. The positive locking pin 926 can include an electrical contact 928.

As illustrated in FIG. 9B, the positive locking pin 926 can be protruded. The positive locking pin 926 can be protruding as a result of the release button (e.g., release button 214, previously described in connection with FIG. 2) being released. As a result of the positive locking pin 926 protruding and a locking pin socket receiving the protruding positive locking pin 926, the keyboard housing (e.g., not illustrated in FIG. 9B) can in a particular position (e.g., the first position, second position, third position, or detached position, as previously described in connection with FIGS. 1-3 and 5-6. When the keyboard housing is in the first position, second position, or third position, the pogo pin can make contact with an electrical connector (e.g., a pogo pin connector) included in a locking pin socket to cause an electrical signal to be transmitted to a processor of the computing device such that the processor of the computing device can determine the position of the keyboard housing.

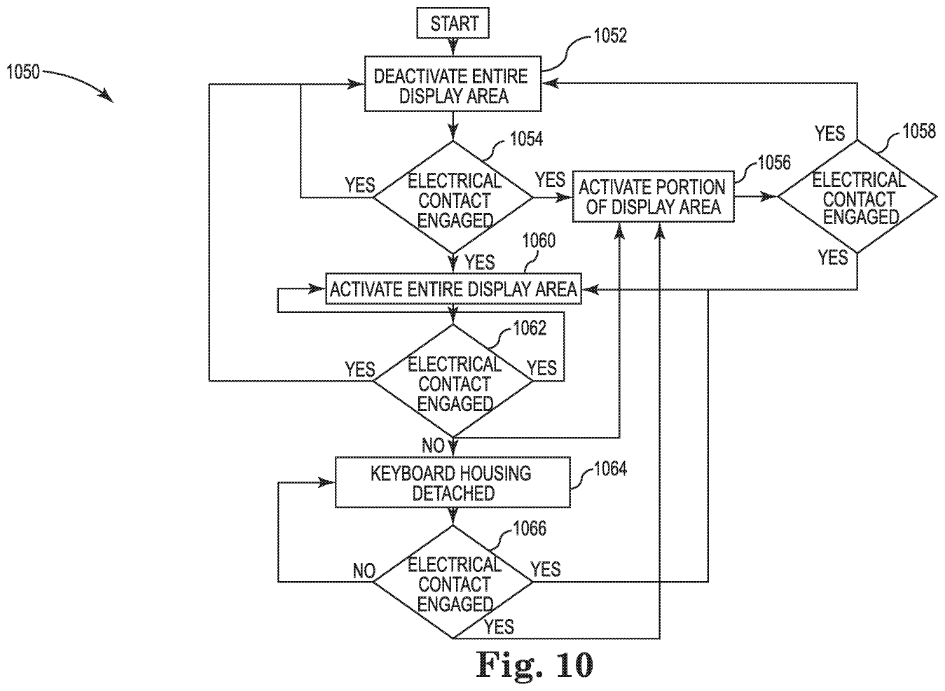

FIG. 10 illustrates an example flow chart 1050 for a computing device with translatable keyboard housings consistent with the disclosure. At 1052, the processor can deactivate the entire display area of the second display. For example, the keyboard housing may be at the first position and covering the entire display area of the second display. A sensor can detect the keyboard housing being at the first position as a result of a first electrical connection being engaged and as a result, cause the processor to deactivate the entire display area of the second display.

At 1054, the processor can check whether a second or third electrical connection is engaged. For example, an electrical connection may be engaged by a positive locking pin having an electrical contact being received by a locking pin socket and making contact with the electrical connection. The electrical contact may be, in some examples, a pogo pin, and the electrical connection may be a pogo pin connector. In response to neither the second or the third electrical connection being engaged, the processor can determine that the keyboard housing is at the first position and to keep the entire display area of the second display deactivated.

In response to the second electrical connection being engaged, at 1056 the processor can cause a portion of the display area of the display to be activated. For example, the keyboard housing may be at the second position such that a portion of the display area of the display is exposed and a portion of the display area of the display is covered by the keyboard housing. Accordingly, the controller can cause the exposed portion of the display to be activated and keep the portion of the display area that is covered by the keyboard housing deactivated. The controller at 1058 can again check whether an electrical connection is engaged. If the second electrical connection is no longer engaged and the first electrical connection is engaged, the processor can cause the entire display area to again be deactivated as a result of the keyboard housing being back at the first position and covering the entire display area of the second display.

In response to the processor determining the third electrical connection is engaged (e.g., either at 1054 or at 1058), the processor can cause the entire display area of the second display to be activated at 1060 as a result of the keyboard housing being at the third position. For example, at the third position of the keyboard housing the entire display area of the second display can be exposed. Accordingly, the controller can cause the entire display area of the display to be activated.

At 1062, the processor can again check whether an electrical connection is engaged. In response to the first electrical connection being engaged (e.g., the keyboard housing is at the first position and covering the entire display area of the second display), the processor can cause the entire display area to be deactivated at 1052. In response to the second electrical connection being engaged (e.g., the keyboard housing is at the second position such that a portion of the display area of the second display is exposed and a portion of the display area of the second display is covered), the processor can cause the exposed portion of the display area to be activated and the covered portion of the display area to be deactivated at 1056. In response to the third electrical connection remaining engaged (e.g., the keyboard housing is still at the third position and exposing the entire display area of the second display), the processor can cause the entire display area to remain activated at 1060.

In response to the processor determining at 1062 that no electrical connections are engaged, the processor can determine at 1064 that the keyboard housing is detached from the second housing. At 1064, the processor can cause the first display and/or the second display to operate in a dual-screen desktop mode, a tablet mode, and/or any other type of mode.

At 1066, the processor can again check whether an electrical connection is engaged. In response to no electrical connections being engaged, the processor can keep the first display and/or the second display operating in a dual-screen desktop mode, a tablet mode, and/or any other type of mode. In response to the first electrical connection being engaged (e.g., the keyboard housing is reattached and is at the first position and covering the entire display area of the second display), the processor can cause the entire display area to be deactivated at 1052. In response to the second electrical connection being engaged (e.g., the keyboard housing is reattached and is at the second position such that a portion of the display area of the second display is exposed and a portion of the display area of the second display is covered), the processor can cause the exposed portion of the display area to be activated and the covered portion of the display area to be deactivated at 1056. In response to the third electrical connection being engaged (e.g., the keyboard housing is reattached and at the third position exposing the entire display area of the second display), the processor can cause the entire display area to remain activated at 1060.

Computing devices with translatable keyboard housings according to the disclosure can allow for a computing device to include two displays to present information to a user while maintaining the mobility of the computing device. For example, a user can utilize the computing device with the first display when the user does not have adequate table space. In an instance in which the user may desire additional display area and/or has additional table space, linearly translate the keyboard housing to expose a portion of or the entire display area of a second display, allowing for additional display area to display information to a user. Further, the keyboard housing may be detached from the second housing having the second display to allow the first display and the second display to operate in a dual-screen mode, a tablet mode, and/or other operational modes. Accordingly, computing devices with translatable keyboard housings can provide additional display space while maintaining and/or enhancing portability of the computing device.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

Elements illustrated in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, “a plurality of” an element and/or feature can refer to more than one of such elements and/or features.

What is claimed:

1. A computing device, comprising:
a first housing;
a second housing;
a first display included in the first housing;
a second display included in the second housing; and
a keyboard housing including a keyboard, wherein:
the keyboard housing is linearly translatable relative to the second housing to change an amount of alignment with the second housing.

2. The computing device of claim 1, wherein the keyboard housing is to be positioned between the first housing and the second housing when the computing device is in a closed position.

3. The computing device of claim 1, wherein:
the second housing is to be aligned with the keyboard housing at a first position of the keyboard housing; and
the keyboard housing is to cover the second display at the first position.

4. The computing device of claim 1, wherein:
the keyboard housing is linearly translatable relative to the second housing to a second position of the keyboard housing to change the amount of alignment with the second housing; and
the keyboard housing is to cover a portion of the second display at the second position.

5. The computing device of claim 1, wherein:
the keyboard housing is linearly translatable relative to the second housing to a third position of the keyboard housing to change the amount of alignment with the second housing; and
the second display is to be uncovered by the keyboard housing at the third position of the keyboard housing.

6. The computing device of claim 5, wherein the keyboard housing is to be oriented at a reflex angle relative to the second housing at the third position of the keyboard housing.

7. The computing device of claim 5, wherein:
wherein the keyboard housing is to be detachable from the second housing at the third position of the keyboard housing such that the keyboard housing is in a detached position; and
the keyboard is wirelessly connectable to a processor of the computing device at the detached position of the keyboard housing.

8. A computing device, comprising:
a hinge;
a first housing attached to the hinge;
a second housing attached to the hinge;
a first display included in the first housing;
a second display included in the second housing, wherein the second housing includes a first portion of a slide rail; and
a keyboard housing including a keyboard and a second portion of the slide rail, wherein:
the second housing is to be aligned with the keyboard housing at a first position of the keyboard housing; and
the keyboard housing is linearly translatable relative to the second housing via the first portion and the second portion to change an amount of alignment with the second housing such that the keyboard housing is to cover different amounts of the second display at different positions of the keyboard housing.

9. The computing device of claim 8, wherein the keyboard housing comprises a release button to allow the keyboard housing to be linearly translatable in response to the release button on the keyboard housing being depressed.

10. The computing device of claim 9, wherein the keyboard housing includes a positive locking pin including an electrical contact to allow the positive locking pin to:
disengage the electrical contact from a connector included in a locking pin socket of the first portion of the slide rail in response to the release button being depressed; and
engage the electrical contact to the connector included in the locking pin socket of the first portion of the slide rail in response to the release button being released.

11. A computing device, comprising:
a first housing;
a second housing;
a first display included in the first housing;
a second display included in the second housing, the second housing being attached to the first housing via a hinge such that the first housing and the second housing are rotatable relative to each other about the hinge, wherein the second housing includes a first portion of a slide rail;
a keyboard housing including a keyboard and a second portion of the slide rail, wherein:
the second housing is to be aligned with the keyboard housing at a first position of the keyboard housing; and
the keyboard housing is linearly translatable relative to the second housing via the slide rail to change an amount of alignment with the second housing such that the keyboard housing is to cover different amounts of the second display at different positions of the keyboard housing; and
a processor to cause a portion of a display area of the second display to be activated based on a determined position of the keyboard housing.

12. The computing device of claim 11, wherein the processor is to deactivate, in response to determining the keyboard housing is at a first position via a first electrical connector of a plurality of electrical connectors, the entire display area of the second display.

13. The computing device of claim 11, wherein the processor is to activate, in response to determining the keyboard housing is at a second position via a second electrical connector of a plurality of electrical connectors, a first portion of the display area of the second display.

14. The computing device of claim 11, wherein the processor is to activate, in response to determining the keyboard housing is at a third position via a third electrical connector of a plurality of electrical connectors, the entire display area of the second display.

15. The computing device of claim 11, wherein the processor is to cause, in response to determining the keyboard housing is at a detached position, the first display and the second display to operate in a tablet mode.
